(19) United States
(12) Patent Application Publication
(10) Pub. No.: US 2025/0338104 A1
(43) Pub. Date: Oct. 30, 2025

(54) SYSTEM AND METHOD FOR PROCESSING EMERGENCY SITUATION OCCURING WHILE USING VEHICLE

(71) Applicants: Hyundai Motor Company, Seoul (KR); Kia Corporation, Seoul (KR)

(72) Inventors: Jin Shun LI, Yantai, (CN); Hanghang WANG, Yantai, (CN)

(21) Appl. No.: 19/188,447

(22) Filed: Apr. 24, 2025

(30) Foreign Application Priority Data
Apr. 26, 2024 (CN) 202410516835.6

(51) Int. Cl. H04W 4/90; G01P 15/18; G08B 21/02; H04W 4/02

(52) U.S. Cl. CPC H04W 4/90; G01P 15/18; G08B 21/02; H04W 4/027

(57) ABSTRACT

Disclosed are a system and a method for responding to an emergency situation. The system may include a plurality of transmitters, each provided at a corresponding location of a plurality of locations of a vehicle; a receiver provided in the vehicle; a motion sensor; a processor; and a memory. The system may classify at least one of the plurality of detection areas as a movement start area and classify at least one of the plurality of detection areas as a movement end area; and determine, based on the motion sensor detecting that the mobile device has been thrown from the movement start area and has landed in the movement end area, that an emergency condition is met. The system may further include a communication circuit configured to output, based on the emergency condition being met, a signal indicating that an emergency situation has occurred.

### CROSS-REFERENCE TO RELATED APPLICATION

This application claims priority to and the benefit of Chinese Patent Application No. 202410516835.6 filed in the China National Intellectual Property Administration on Apr. 26, 2024, the entire contents of which are incorporated herein by reference.

### FIELD

The present disclosure relates to vehicle control technology, and more particularly, to a system and a method for processing an emergency situation occurring while using a vehicle.

### BACKGROUND

An emergency situation occurring while using a vehicle may include an unexpected situation (e.g. kidnapping, robbery, or assault) that may occur while an occupant is getting on or off the vehicle or inside the vehicle. If such an emergency situation suddenly occurs, the vehicle occupant may become disoriented and lose the ability to notify a first responder (e.g. a pedestrian around the vehicle or a police officer) of the emergency situation and ask for help. Therefore, when an emergency situation occurs, there is a high possibility that the first responder will not be aware of the emergency situation such that the emergency situation will continue without the first responder's intervention.

Therefore, it would be beneficial to be able to notify the first responder of the occurrence of the emergency situation by sending an alert as quickly as possible. Additionally, since the vehicle occupant may lose the ability to notify the emergency situation and to ask for help, it would be beneficial to be able to automatically notify the first responder and require only subtle and covert actions from the vehicle occupant.

The information contained in this background section has been provided to enhance understanding of the background of the disclosure, and may contain information that does not form the prior art that is already known to those skilled in the art.

### SUMMARY

The present disclosure attempts to provide a system and a method for processing an emergency situation occurring while using a vehicle capable of enabling an occupant to covertly send an alert, notify that an emergency situation has occurred, and ask for help by throwing a mobile device (e.g., smartphone) if the occupant is kidnapped, robbed, attacked, or beaten by a criminal while getting on or off the vehicle or being inside the vehicle.

According to one or more example embodiments of the present disclosure, a system may include: a plurality of transmitters, each provided at a corresponding location of a plurality of locations of a vehicle and configured to transmit a request signal associated with a corresponding detection area of a plurality of detection areas inside or outside the vehicle; a receiver provided in the vehicle and configured to receive a response signal, wherein the response signal is transmitted by a mobile device in response to the mobile device receiving the request signal after the mobile device enters a detection area of the plurality of detection areas; a motion sensor configured to detect, based on the response signal of the mobile device and the request signal of the transmitters, a movement of the mobile device; a processor; a memory; and a communication circuit. The memory may store at least one instruction that, when executed by the processor communicating with the memory, is configured to cause the system to: classify at least one of the plurality of detection areas as a movement start area and classify at least one of the plurality of detection areas as a movement end area; and determine, based on the motion sensor detecting that the mobile device has been thrown from the movement start area and has landed in the movement end area, that an emergency condition is met. The communication circuit may be configured to output, based on the emergency condition being met, a signal indicating that an emergency situation has occurred.

The motion sensor may be further configured to: determine, based on a change in a location of the mobile device being detected, an acceleration of the mobile device; and detect, based on the acceleration being greater than a threshold acceleration, that the mobile device has been thrown.

The motion sensor may be configured to determine the acceleration of the mobile device using the following equation:

$$A = \sqrt{{( \frac{{x}_{t + Δ t} - {x}_{t}}{Δ {t}^{2}} )}^{2} + {( \frac{{y}_{t + Δ t} - {y}_{t}}{Δ {t}^{2}} )}^{2}}$$

A may denote the acceleration of the mobile device. Δt may denote an elapsed time. xₜ may denote a horizontal coordinate of a first location of the mobile device at a time t. yₜ may denote a vertical coordinate of the first location of the mobile device at the time t. x_{t+Δt} may denote a horizontal coordinate of a second location of the mobile device after the elapsed time Δt. y_{t+Δt} may denote a vertical coordinate of the second location of the mobile device after the elapsed time Δt.

Based on the movement start area being a driver activity area, the movement end area corresponding to the driver activity area may include a front occupant seat area or a rear occupant seat area located immediately behind the driver activity area. Based on the movement start area being a driver-side door opening area, the movement end area corresponding to the driver-side door opening area may include one of a driver seat area, the front occupant seat area, the rear occupant seat area located immediately behind the driver activity area, a rear occupant seat area located immediately behind the front occupant seat area, an area located immediately in front of the driver-side door opening area, an area located immediately behind the driver-side door opening area, a vehicle front area, or a vehicle side area close to the vehicle. Based on the movement start area being a vehicle side area, the movement end area corresponding to the vehicle side area may include one of the area located immediately in front of the driver-side door opening area, the area located immediately behind the driver-side door opening area, the vehicle front area, or the vehicle side area close to the vehicle. A distance from the vehicle side area to the vehicle may be greater than a threshold distance.

The motion sensor may be further configured to: sequentially detect whether the mobile device is located in one movement start area among the driver activity area, the driver-side door opening area, and the vehicle side area; based on detecting that the mobile device is located in the one movement start area, detect whether the change in the location of the mobile device has occurred; detect, based on detecting that the mobile device has been thrown, whether the mobile device is located in the movement end area corresponding to the one movement start area; and detect, based on detecting that the mobile device is located in the movement end area corresponding to the one movement start area, that the mobile device has been thrown from the one movement start area and has landed in the movement end area.

The system may further include: a sensor configured to detect whether there is a person in the rear occupant seat area. The at least one instruction, when executed by the processor communicating with the memory, may be configured to cause the system to determine that the emergency condition is not met based on the sensor detecting that there is no person in the rear occupant seat area when the motion sensor detects that the mobile device has been thrown from the driver activity area and has landed in the front occupant seat area or the rear occupant seat area located immediately behind the driver activity area.

The at least one instruction, when executed by the processor communicating with the memory, may be further configured to cause the system to: send, to the mobile device, a message indicating that the mobile device has been thrown and that the emergency condition is met; and determining that the emergency situation is invalid based on the system receiving, within a predetermined time duration, a user input via the mobile device or a button installed on a steering wheel, that the emergency situation has occurred.

The communication circuit may be configured to output the signal indicating that the emergency situation has occurred by performing at least one of: reporting to police, sending vehicle location information to an emergency contact person, sending a vehicle exterior image to the emergency contact person, notifying an Internet vehicle, or placing the vehicle into an alert state.

The communication circuit may be configured to output the signal indicating that the emergency situation has occurred by selecting a notification method based on the movement start area from which the mobile device has been thrown.

The communication circuit may be configured to not notify that the emergency situation has occurred, based on the motion sensor detecting that the mobile device has been thrown from a driver activity area and has landed in a front occupant seat area or a rear occupant seat area located immediately behind the driver activity area.

According to one or more example embodiments of the present disclosure, a method performed by an apparatus of a vehicle may include: transmitting, via at least one of a plurality of transmitters installed at a plurality of locations of the vehicle, a request signal associated with a detection area of a plurality of detection areas inside or outside the vehicle; receiving, via a receiver installed in the vehicle, a response signal, wherein the response signal is transmitted by a mobile device in response to the mobile device receiving the request signal after the mobile device enters the detection area; classifying at least one of the plurality of detection areas as a movement start area and classifying at least one of the plurality of detection areas as a movement end area; based on the response signal of the mobile device and the request signal of the transmitter, detecting, via a motion sensor, whether the mobile device has been thrown from the movement start area and has landed in the movement end area; determining, based on detecting that the mobile device has been thrown from the movement start area and has landed in the movement end area, that an emergency condition is met; and outputting, based on the emergency condition being met, a signal indicating that an emergency situation has occurred.

Detecting whether the mobile device has been thrown may include: determining, based on a change in a location of the mobile device being detected, an acceleration of the mobile device; and detecting, based on the acceleration being greater than a threshold acceleration, that the mobile device has been thrown.

Determining the acceleration may include: determining the acceleration of the mobile device using the following equation:

$$A = \sqrt{{( \frac{{x}_{t + Δ t} - {x}_{t}}{Δ {t}^{2}} )}^{2} + {( \frac{{y}_{t + Δ t} - {y}_{t}}{Δ {t}^{2}} )}^{2}}$$

A may denote the acceleration of the mobile device. Δt may denote an elapsed time. xₜ may denote a horizontal coordinate of a first location of the mobile device at a time t. yₜ may denote a vertical coordinate of the first location of the mobile device at the time t. x_{t+Δt} may denote a horizontal coordinate of a second location of the mobile device after the elapsed time Δt. y_{t+Δt} may denote a vertical coordinate of the second location of the mobile device after the elapsed time Δt.

Based on the movement start area being a driver activity area, the movement end area corresponding to the driver activity area may include a front occupant seat area or a rear occupant seat area located immediately behind the driver activity area. Based on the movement start area being a driver-side door opening area, the movement end area corresponding to the driver-side door opening area may include one of a driver seat area, the front occupant seat area, the rear occupant seat area located immediately behind the driver activity area, a rear occupant seat area located immediately behind the front occupant seat area, an area located immediately in front of the driver-side door opening area, an area located immediately behind the driver-side door opening area, a vehicle front area, or a vehicle side area close to the vehicle. Based on the movement start area being a vehicle side area, the movement end area corresponding to the vehicle side area may include one of the area located immediately in front of the driver-side door opening area, the area located immediately behind the driver-side door opening area, the vehicle front area, or the vehicle side area close to the vehicle, wherein a distance from the vehicle side area to the vehicle is greater than a threshold distance.

Detecting whether the mobile device has been thrown may include: based on detecting that the mobile device is located in the one movement start area, detecting whether the change in the location of the mobile device has occurred; detecting, based on the acceleration being greater than the threshold acceleration, whether the mobile device is located in the movement end area corresponding to the driver activity area; and detecting, based on detecting that the mobile device is located in the movement end area corresponding to the driver activity area, that the mobile device has been thrown from the movement start area and has landed in the movement end area.

The method may further include: detecting, by a sensor, whether there is any person in the rear occupant seat area based on the mobile device being detected as having been thrown from the driver activity area and landed in the front occupant seat area or the rear occupant seat area located immediately behind the driver activity area; and determining that the emergency condition is not met based on the sensor detecting that there is no person in the rear occupant seat area.

The method may further include: sending, to the mobile device, a message indicating that the mobile device has been thrown and that the emergency condition is met; and determining that the emergency situation is invalid based on the apparatus receiving, within a predetermined time duration, a user input via the mobile device or a button installed on a steering wheel, that the emergency situation has occurred.

Outputting the signal may include: performing at least one of: reporting to police, sending vehicle location information to an emergency contact person, sending a vehicle exterior image to the emergency contact person, notifying an Internet vehicle, or placing the vehicle into an alert state.

Outputting the signal may include: outputting of the signal indicating that the emergency situation has occurred by selecting a notification method based on the movement start area from which the mobile device has been thrown.

According to one or more example embodiments of the present disclosure, a vehicle may include: a motion sensor configured to detect, based on a location of a mobile device within one of a plurality of detection areas associated with the vehicle, a movement of the mobile device; a processor; a memory; and a communication circuit. The memory may store at least one instruction that, when executed by the processor communicating with the memory, is configured to cause the vehicle to: classify at least one of the plurality of detection areas as a movement start area and classify at least one of the plurality of detection areas as a movement end area; and determine, based on the motion sensor detecting that the mobile device has been thrown from the movement start area and has landed in the movement end area, that an emergency condition is met. The communication circuit may be configured to output, based on the emergency condition being met, a signal indicating that an emergency situation has occurred.

Other effects that can be obtained or expected from example embodiments of the present disclosure will be directly or implicitly disclosed in the detailed description of one or more example embodiments of the present disclosure. That is, various effects expected according to the example embodiments of the present disclosure will be disclosed in the following detailed description.

### BRIEF DESCRIPTION OF THE DRAWINGS

Hereinafter, one or more example embodiments of the present disclosure will be described in more detail with reference to the drawings. For clarity, the same components are denoted by the same reference signs across different drawings. It should be noted that the drawings are illustrative only and are not necessarily drawn to scale.

FIG. 1 is a block diagram of a system for processing an emergency situation occurring while using a vehicle.

FIG. 2 schematically illustrates locations of transmitters.

FIG. 3 is a block diagram illustrating specific components for accurately determining a location of a mobile device using an ultra-wideband (UWB) technology.

FIG. 4 schematically illustrates movement start areas and movement end areas.

FIGS. 5A, 5B, and 5C illustrate a flowchart of steps for determining whether an emergency condition is met.

FIGS. 6A and 6B illustrate flowcharts of steps for finally determining whether an emergency situation has occurred.

FIG. 7 shows an example computing system.

### DETAILED DESCRIPTION

Hereinafter, one or more example embodiments of the present disclosure will be described in detail. The present example embodiments are implemented based on the technical solution of the present disclosure, and a detailed implementation method and a specific operation process are disclosed, but the protection scope of the present disclosure is not limited to the following example embodiments.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip”, “second chip”, respectively.

The term “unit” or “device” as used herein may refer to software, or hardware component such as Field-Programmable Gate Array (FPGA), Application Specific Integrated Circuit (ASIC), etc. However, “unit” and “device” are not limited to hardware and software. The “unit” or “device” may be configured to be stored in an addressable storage medium, or may be configured to execute one or more processors. The “unit” or “device” may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based on” as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

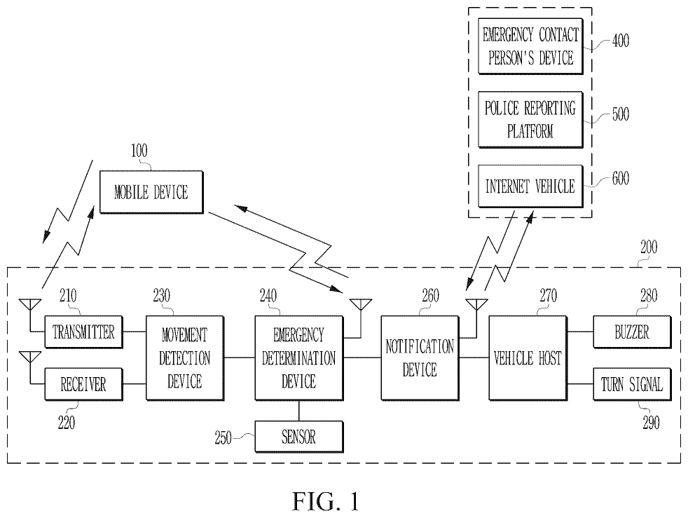

FIG. 1 is a block diagram of a system for processing an emergency situation occurring while using a vehicle. As illustrated in FIG. 1, a system for processing an emergency situation occurring while using a vehicle includes a mobile device 100 (e.g., smartphone) carried by a vehicle occupant and a vehicle-side device 200 mounted in the vehicle.

The vehicle-side device 200 may include a plurality of transmitters 210, and the plurality of transmitters 210 may be installed at a plurality of locations of the vehicle and transmit request signals. The request signals may form detection areas inside and outside the vehicle.

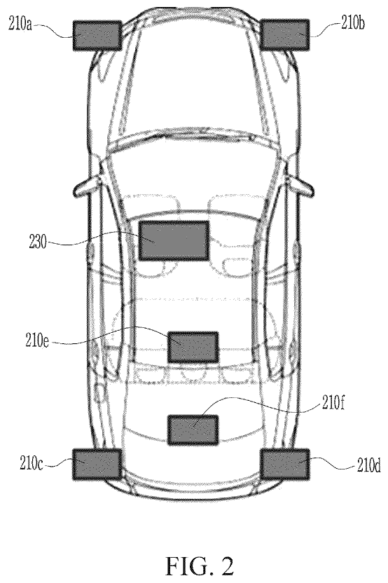

FIG. 2 schematically illustrates locations of transmitters. As illustrated in FIG. 2, the plurality of transmitters 210 includes at least a first transmitter 210a to a sixth transmitter 210f. The first transmitter 210a is provided at a left front of a vehicle body, the second transmitter 210b is provided at a right front of the vehicle body, the third transmitter 210c is provided at a left rear of the vehicle body, the fourth transmitter 210d is provided at a right rear of the vehicle body, the fifth transmitter 210e is provided inside the vehicle body (specifically, on a roof on a center axis of the vehicle and above a rear seat), and the sixth transmitter 210f is provided in a rear trunk of the vehicle (specifically, the rear trunk on the center axis of the vehicle). Each of the first transmitter 210a to the sixth transmitter 210f may transmit the request signal. The request signal may be transmitted from the corresponding transmitter 210 and the detection area may be formed by setting a predetermined distance from the corresponding transmitter 210 as a transmission radius. Since the first transmitter 210a to the sixth transmitter 210f are provided at the four corners of the vehicle, inside the vehicle, and in the rear trunk of the vehicle, respectively, the detection areas formed by the first transmitter 210a to the sixth transmitter 210f may cover the inside of the vehicle and the outside of the vehicle within a predetermined range.

When the mobile device 100 (e.g., smartphone) enters the detection areas formed by the request signals, the mobile device 100 may transmit a response signal in response to the request signals. The vehicle-side device 200 includes a receiver 220, and the receiver 220 is provided in the vehicle and receives the response signal from the mobile device 100.

The vehicle-side device 200 may further include a movement detection device 230 (e.g., a motion sensor, such as a camera, an ultrasonic sensor, etc.), and the movement detection device 230 may detect a movement of the mobile device 100 based on the response signal of the mobile device 100 and the request signals of the transmitters 210.

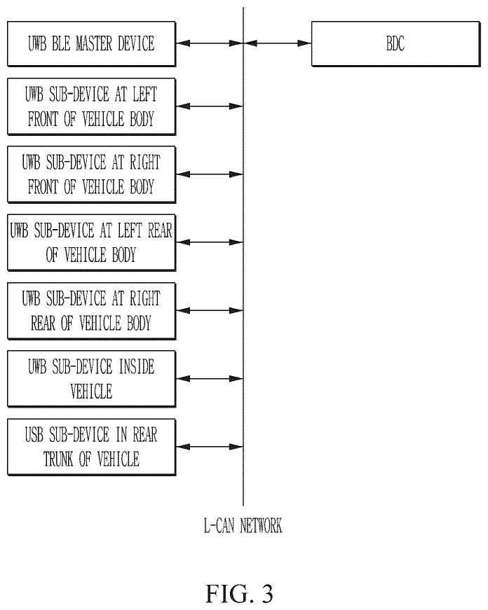

The movement of the mobile device 100 may be detected by accurately determining the location of the mobile device 100 using an ultra-wideband (UWB) technology. FIG. 3 is a block diagram illustrating specific components for accurately determining a location of a mobile device through an UWB technology. As illustrated in FIG. 3, UWB sub-devices and a UWB Bluetooth low energy (BLE) master device located at the four corners of the vehicle, inside the vehicle, and in the rear trunk of the vehicle may communicate with a body domain controller (BDC) via a local controller area network (L-CAN), and each of the UWB sub-devices may communicate with the UWB BLE master device via the L-CAN of the vehicle. Each of the UWB sub-devices and the UWB BLE master device communicate with the mobile device 100.

The transmitters 210 may be implemented via the plurality of UWB sub-devices. The plurality of UWB sub-devices is provided to correspond to the positions of the first transmitter 210a to the sixth transmitter 210f, respectively. In addition to transmitting the request signal, the UWB sub-device may receive the response signal from the mobile device 100 as the receiver 220. The movement detection device 230 may be implemented via the UWB BLE master device. When the mobile device 100 is far away from the vehicle, the UWB BLE master device first performs rough positioning via BLE. When the mobile device 100 approaches the vehicle, the UWB BLE master device performs accurate positioning via UWB.

Specifically, while performing the accurate positioning via the UWB, the BDC sends a transmission request signal to the UWB sub-device. Upon receiving the transmission request signal from the BDC, the UWB sub-device may transmit the request signal. Further, the mobile device 100 transmits the response signal in response to the request signal of the UWB sub-device, and then the UWB sub-device transmits the response signal received from the mobile device 100 to the UWB BLE master device. The UWB sub-device may transmit the request signal at every predetermined time interval, and the UWB BLE master device may receive the response signal from each of the UWB sub-devices.

That is, the UWB BLE master device may determine a time point when the response signal is provided, and accordingly, the UWB BLE master device may measure a time delay between the request signal and the response signal. Since the plurality of UWB sub-devices is spatially distributed and all the plurality of UWB sub-devices communicate with the mobile device 100, the UWB BLE master device may calculate an exact location of the mobile device 100 by measuring a difference in the time delays between the mobile device 100 and the UWB sub-devices using a triangulation method or the like. However, the present disclosure is not limited thereto, and the UWB BLE master device may accurately calculate the location of the mobile device 100 through another UWB positioning calculation method.

If an occupant is kidnapped, robbed, or attacked while getting on or off the vehicle or being inside the vehicle, the occupant may notify that such an emergency situation has occurred and ask for help by throwing the mobile device 100 (e.g., smartphone) to covertly send an alert. In order to ensure that the mobile device 100 is moved due to the occurrence of the emergency situation, it is necessary to set an emergency situation occurrence condition. Specifically, it may be primarily determined that the emergency situation has occurred only when movement start and end locations of the mobile device 100 and parameters (e.g., acceleration) during the movement of the mobile device meet a predetermined condition.

Therefore, as illustrated in FIG. 1, the vehicle-side device 200 may include an emergency determination device 240. The emergency determination device 240 may classify at least some of the detection areas into at least one movement start area and at least one movement end area. The movement start area refers to an area from which the mobile device 100 may be thrown, and the movement end area refers to an area in which the mobile device 100 may land.

Since the movement detection device 230 is capable of determining the location of the mobile device 100, the movement detection device 230 may determine which movement start area and which movement end area the mobile device 100 is located in among the plurality of movement start areas and the plurality of movement end areas. In addition, the movement detection device 230 may additionally detect whether a change in the location of the mobile device 100 has occurred. That is, the movement detection device 230 may detect whether the mobile device 100 has moved from one area to another area among the plurality of movement start areas and the plurality of movement end areas.

Specifically, the emergency situation that the occupant encounters while using the vehicle may include the emergency situation that the occupant encounters when the occupant is located inside the vehicle while the vehicle is traveling or while the vehicle is stopped and the occupant is located around the vehicle after the vehicle is parked (for example, when getting on or off the vehicle near a door), or when the occupant is located at a position far away from the vehicle (for example, when gradually approaching the vehicle from a location far away from the vehicle or staying within a certain distance away from the vehicle). If the occupant throws the mobile device 100 from inside the vehicle, the area in which the mobile device 100 lands should also be located inside the vehicle. If the occupant throws the mobile device 100 from around the vehicle, a range of the area in which the mobile device 100 lands increases. That is, the area in which the mobile device 100 lands may be located inside the vehicle, around the vehicle (that is, near a contour of the vehicle body), or at an area far away from the vehicle but not beyond the detection area. In a case where the occupant throws the mobile device 100 from a location far away from the vehicle, if the mobile device 100 is thrown toward a location further away from the vehicle, the mobile device 100 will go out of the detection area range. Therefore, the area in which the mobile device 100 lands may be located in an area around the vehicle or close to the vehicle.

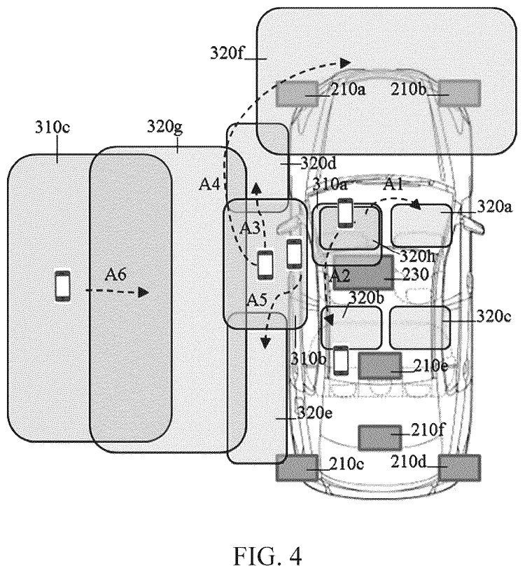

FIG. 4 schematically illustrates movement start areas and movement end areas. As illustrated in FIG. 4, in a case of a driver who is essential among the occupants, the movement start area may include a driver activity area 310a, a driver-side door opening area 310b, and a vehicle side area 310c far away from the vehicle.

When the movement start area is the driver activity area 310a, the movement end area corresponding to the driver activity area 310a includes a front occupant seat area 320a or a rear occupant seat area 320b located immediately behind the driver activity area 310a. Therefore, in a case where the driver encounters the emergency situation inside the vehicle, if the driver is holding the mobile device 100 (e.g., smartphone) in his or her right hand, the driver can throw the smartphone from the driver activity area 310a toward the front occupant seat area 320a next to the driver activity area 310a. If the driver is holding the smartphone in his/her left hand, the driver may throw the smartphone from the driver activity area 310a through a space near the driver seat toward the rear occupant seat area 320b located immediately behind the driver activity area 310a. For example, the smartphone may move along a trajectory in a direction indicated by an arrow A1 or A2.

When the movement start area is the driver-side door opening area 310b, the movement end area corresponding to the driver-side door opening area 310b includes one of a driver seat area 320h, the front occupant seat area 320a, the rear occupant seat area 320b located immediately behind the driver activity area 310a, a rear occupant seat area 320c located immediately behind the front occupant seat area 320a, an area 320d located immediately in front of the driver-side door opening area 310b, an area 320e located immediately behind the driver-side door opening area 310b, a vehicle front area 320f, and a vehicle side area 320g close to the vehicle. Therefore, if the driver encounters the emergency situation while getting on or off the vehicle after parking the vehicle, the driver can throw the smartphone to any area into which the smartphone can be easily thrown from the driver-side door opening area 310b. The driver can safely and covertly throw the smartphone in accordance with the situation. For example, the smartphone may move along a trajectory in a direction indicated by an arrow A3, A4, or A5.

When the movement start area is the vehicle side area 310c far away from the vehicle, the movement end area corresponding to the vehicle side area 310c far away from the vehicle includes one of the area 320d located immediately in front of the driver-side door opening area 310b, the area 320e located immediately behind the driver-side door opening area 310b, the vehicle front area 320f, and the vehicle side area 320g close to the vehicle. Therefore, if the driver encounters the emergency situation while gradually approaching the vehicle from the location far away from the vehicle or while staying the certain distance away from the vehicle, the driver can throw the smartphone to an area closer to the vehicle. For example, the smartphone may move along a trajectory in a direction indicated by an arrow A6.

In addition, the movement detection device 230 may calculate an acceleration of the mobile device 100 to determine whether the mobile device 100 has been thrown. Therefore, when the driver normally places the mobile device 100 after using the mobile device 100 or when the mobile device 100 moves slightly due to shaking of the vehicle while the vehicle is traveling, this can be prevented from being determined as the occurrence of the emergency situation.

Specifically, when the movement detection device 230 detects the change in the location of the mobile device 100, the movement detection device 230 may calculate the acceleration of the mobile device 100 in real time and determine whether the calculated acceleration is greater than a threshold acceleration. When the calculated acceleration is greater than the threshold acceleration, the movement detection device 230 may determine that the mobile device 100 has been thrown. In addition, the calculated acceleration greater than the threshold acceleration may be an acceleration at a moment when the mobile device 100 lands and suddenly stops.

When calculating the acceleration of the mobile device 100, accelerations on horizontal and vertical coordinates of the mobile device 100 may be calculated, and the acceleration in an actual movement direction may be calculated according to the accelerations on the horizontal and vertical coordinates. Therefore, the acceleration of the mobile device 100 may be calculated by the following formula.

$$a = \sqrt{{a}_{x}^{2} + {a}_{y}^{2}}$$

$$a = \sqrt{{( \frac{{x}_{t + Δ t} - {x}_{t}}{Δ {t}^{2}} )}^{2} + {( \frac{{y}_{t + Δ t} - {y}_{t}}{Δ {t}^{2}} )}^{2}}$$

Here, a denotes the acceleration of the mobile device 100, aₓ denotes the acceleration of the mobile device 100 along the horizontal coordinate, a_{y} denotes the acceleration of the mobile device 100 along the vertical coordinate, At denotes an elapsed time, xₜ denotes a horizontal coordinate of a location of the mobile device 100 at a current time t, yₜ denotes a vertical coordinate of the location of the mobile device 100 at the current time t, x_{t+Δt} denotes a horizontal coordinate of a location of the mobile device 100 after the elapsed time Δt, and y_{t+Δt} denotes a vertical coordinate of the location of the mobile device 100 after the elapsed time Δt.

By setting the threshold acceleration, the acceleration when the mobile device 100 is thrown can be distinguished from the acceleration of the mobile device 100 when the driver normally places the mobile device 100 after using the mobile device 100 and the acceleration of the mobile device 100 when the mobile device 100 moves slightly due to the shaking of the vehicle while the vehicle is traveling.

Summarizing what has been described above, the movement detection device 230 may detect whether the mobile device 100 has been thrown from the movement start area and has landed in the movement end area. Specifically, the movement detection device 230 may sequentially determine whether the mobile device 100 is located in one of the driver activity area 310a, the driver-side door opening area 310b, and the vehicle side area 310c far away from the vehicle. When it is detected that the mobile device 100 is located in one of the driver activity area 310a, the driver-side door opening area 310b, and the vehicle side area 310c far away from the vehicle, the movement detection device 230 may determine whether the change in the location of the mobile device 100 has occurred. When the change in the location of the mobile device 100 is detected, the movement detection device 230 may calculate the acceleration of the mobile device 100 in real time and determine whether the calculated acceleration is greater than the threshold acceleration. When the calculated acceleration is greater than the threshold acceleration, the movement detection device 230 may detect that the mobile device 100 has been thrown. When it is detected that the mobile device has been thrown, the movement detection device 230 may determine whether the mobile device 100 is located in the corresponding movement end area. When it is detected that the mobile device 100 is located in the corresponding movement end area, the movement detection device 230 may detect that the mobile device 100 has been thrown from the movement start area and has landed in the movement end area.

In one example, the emergency determination device 240 may determine that an emergency condition is met based on the movement detection device 230 detecting that the mobile device 100 has been thrown from the movement start area and has landed in the movement end area. Specifically, in a case where the movement start area is the driver-side door opening area 310b or the vehicle side area 310c far away from the vehicle, this means that the driver is located around the vehicle or within the certain distance away from the vehicle, and the emergency determination device 240 may determine whether the emergency condition is met only based on the detection result of the movement detection device 230.

In another example, since various sensors are mounted on the vehicle, if the emergency situation occurs inside the vehicle, the emergency determination device 240 may determine whether the emergency condition is met by referring to the detection results of the sensors in addition to the detection result of the movement detection device 230.

Specifically, a sensor 250 may detect whether there is a person (i.e., a person kidnapping, robbing, or attacking the occupant in the vehicle) in the rear occupant seat area. Such the sensor may be a rear occupant alert (ROA) device. The ROA device may monitor a rear seat situation and detect a movement of the occupant (including a living thing such as a pet) using an ultrasonic wave. When the movement detection device 230 detects that the mobile device 100 has been thrown from the driver activity area 310a and has landed in the front occupant seat area 320a or the rear occupant seat area 320b located immediately behind the driver activity area 310a, this means that the driver is inside the vehicle. In this case, further based on the sensor 250 (specifically, the ROA device) detecting that there is no person in the rear occupant seat area, the emergency determination device 240 may determine that the emergency condition is not met. Conversely, when the ROA device detects that there is a person in the rear occupant seat area, the emergency determination device 240 may determine that the emergency condition is met. Therefore, by referring to the detection result of the sensor 250, it is possible to prevent the emergency determination device 240 from determining a situation where the mobile device 100 moves by bouncing away as the vehicle changes its direction while travelling as the emergency situation.

In addition, the driver may finally determine whether the emergency situation has occurred. Specifically, when the emergency determination device 240 determines that the emergency condition is met, the emergency determination device 240 sends a message to the mobile device 100 regarding the mobile device 100 having been thrown. Based on the emergency determination device 240 receiving a user input confirming the message via the mobile device 100 and/or a button installed on a steering wheel within a predetermined time, the emergency determination device 240 may finally determine that no emergency situation has occurred. Conversely, when the emergency determination device 240 does not receive the user input confirming the message via the mobile device 100 and/or the button installed on the steering wheel within the predetermined time, the emergency determination device 240 may finally determine that the emergency situation has occurred.

Specifically, the emergency determination device 240 may be implemented through the BDC. Additionally, a communication module is provided inside the vehicle. The BDC sends a text message to the smartphone, such as “your phone has been thrown” using the communication module. The smartphone may display a confirmation button for the user's input together with the message. The BDC may stand by, for example, for about 10 seconds to check whether the user has responded. When the driver presses the confirmation button, the BDC may determine that no emergency situation has occurred because the smartphone has moved due to a driver's abnormal operation. If the BDC does not receive a response from the driver within 10 seconds, the BDC may determine that the emergency situation has occurred because the movement of the smartphone has been caused by the emergency situation.

If the movement detection device 230 detects that the mobile device 100 has been thrown from the driver activity area 310a and has landed in the front occupant seat area 320a or the rear occupant seat area 320b located immediately behind the driver activity area 310a, and the ROA device detects that there is a person in the rear occupant seat area, it may be predicted that the driver is driving the vehicle inside the vehicle. In this state, when the driver's smartphone and the vehicle are connected to each other, the driver may respond to the message by pressing the button installed on the steering wheel, specifically through a steering wheel remote controller (SWRC), rather than clicking the confirmation button on the smartphone.

The vehicle-side device 200 further includes a notification device 260. When the emergency condition is met or it is determined that the emergency situation has occurred, the notification device 260 may notify the occurrence of the emergency situation. For example, the notification device may notify the occurrence of the emergency situation by at least one way among reporting to police, sending vehicle location information and a vehicle exterior image to an emergency contact person, notifying an Internet vehicle, and putting the vehicle into an alert state.

Specifically, the notification device 260 may report the occurrence of the emergency situation to police reporting platform 500 through the communication module provided in the vehicle. The notification device 260 may transmit the vehicle location information and the vehicle exterior image (that may include surroundings and exterior environments around the vehicle, and may even include an image of a criminal) stored in a vehicle host 270 to an emergency contact person's device 400 to provide an image evidence for investigation to be carried out later by law enforcement personnel. The notification device 260 may call the Internet vehicle 600 to request help. The vehicle host 270 may put the vehicle into the alert state by controlling a buzzer 280 of the vehicle to sound and left and right turn signals 290 to be blinked.

In one example, the notification device 260 may notify the occurrence of the emergency situation in a different way depending on the movement start area from which the mobile device 100 has been thrown. When the movement detection device 230 detects that the mobile device 100 has been thrown from the driver activity area 310a and has landed in the front occupant seat area 320a or the rear occupant seat area 320b located immediately behind the driver activity area 310a, this means that the driver has encountered the emergency situation inside the vehicle. In this case, since the vehicle is likely to drive normally, the notification device 260 does not notify the occurrence of the emergency situation by putting the vehicle into the alert state.

Specifically, the notification device 260 may be implemented through an audio, video, navigation and telematics (AVNT) system of the vehicle.

The present disclosure further provides a method for processing the emergency situation occurring while using the vehicle. The method includes: transmitting, by the plurality of transmitters 210 installed at the plurality of locations of the vehicle, the request signal forming the detection area inside and outside the vehicle; transmitting, by the mobile device 100, the response signal in response to the request signal when the mobile device 100 enters the detection area; receiving, by the receiver 220 installed in the vehicle, the response signal from the mobile device 100; classifying, by the emergency determination device 240, the at least some of the detection areas into at least one movement start area and at least one movement end area; detecting, by the movement detection device 230, whether the mobile device 100 has been thrown from the movement start area and has landed in the movement end area based on the response signal of the mobile device 100 and the request signal of the transmitters 210; determining, by the emergency determination device 240, that the emergency condition is met based on the movement detection device 230 detecting that the mobile device 100 has been thrown from the movement start area and has landed in the movement end area; and notifying, by the notification device 260, that the emergency situation has occurred when the emergency condition is met.

The detecting, by the movement detection device 230, whether the mobile device 100 has been thrown from the movement start area and has landed in the movement end area includes calculating, by the movement detection device 230, the acceleration of the mobile device 100 in real time when the movement detection device 230 detect the change in the location of the mobile device 100, and detecting, by the movement detection device 230, that the mobile device has been thrown when the calculated acceleration is greater than the threshold acceleration.

Specifically, the acceleration of the mobile device 100 is calculated by the following formula.

$$a = \sqrt{{( \frac{{x}_{t + Δ t} - {x}_{t}}{Δ {t}^{2}} )}^{2} + {( \frac{{y}_{t + Δ t} - {y}_{t}}{Δ {t}^{2}} )}^{2}}$$

Here, a denotes the acceleration of the mobile device 100, Δt denotes the elapsed time, xₜ denotes the horizontal coordinate of the location of the mobile device 100 at the current time t, yₜ denotes the vertical coordinate of the location of the mobile device 100 at the current time t, x_{t+Δt} denotes the horizontal coordinate of the location of the mobile device 100 after the elapsed time Δt, and y_{t+Δt} denotes the vertical coordinate of the location of the mobile device 100 after the elapsed time Δt.

Specifically, when the movement start area is the driver activity area 310a, the movement end area corresponding to the driver activity area 310a includes the front occupant seat area 320a or the rear occupant seat area 320b located immediately behind the driver activity area 310a.

When the movement start area is the driver-side door opening area 310b, the movement end area corresponding to the driver-side door opening area 310b includes one of the driver seat area 320h, the front occupant seat area 320a, the rear occupant seat area 320b located immediately behind the driver activity area 310a, the rear occupant seat area 320c located immediately behind the front occupant seat area 320a, the area 320d located immediately in front of the driver-side door opening area 310b, the area 320e located immediately behind the driver-side door opening area 310b, the vehicle front area 320f, and the vehicle side area 320g close to the vehicle.

When the movement start area is the vehicle side area 310c far away from the vehicle, the movement end area corresponding to the vehicle side area 310c far away from the vehicle includes one of the area 320d located immediately in front of the driver-side door opening area 310b, the area 320e located immediately behind the driver-side door opening area 310b, the vehicle front area 320f, and the vehicle side area 320g close to the vehicle.

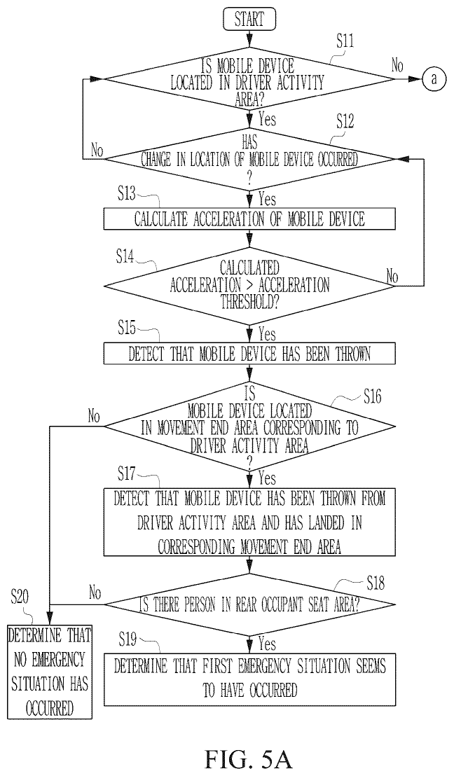

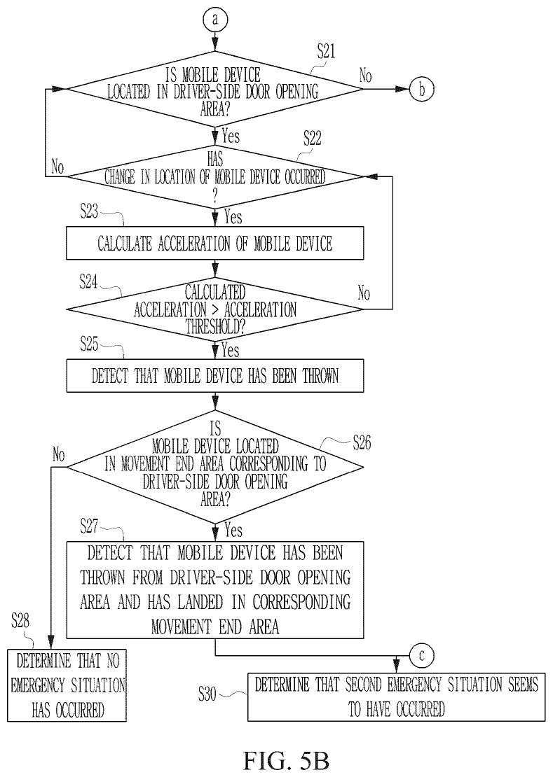

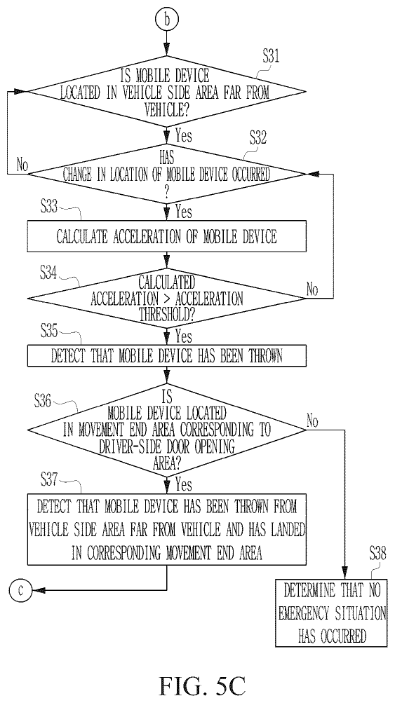

Based on the movement start area and movement end area classified above, FIGS. 5A, 5B, and 5C illustrate a flowchart of steps for determining whether the emergency condition is met.

As illustrated in FIGS. 5A, 5B, and 5C, the movement detection device 230 detects whether the mobile device 100 is located in the driver activity area 310a in step S11.

When it is detected that the mobile device 100 is located in the driver activity area 310a (“Yes” in the step S11), the movement detection device 230 and/or the movement detection device 230 may detect whether the change in the location of the mobile device 100 has occurred in step S12. When the change in the location of the mobile device 100 is detected (“Yes” in the step S12), the movement detection device 230 and/or the movement detection device 230 may calculate the acceleration of the mobile device 100 in real time in step S13, and determine whether the calculated acceleration is greater than the threshold acceleration in step S14. If the calculated acceleration is greater than the threshold acceleration (“Yes” in the step S14), the movement detection device 230 and/or the movement detection device 230 may detect that the mobile device 100 has been thrown in step S15. When the calculated acceleration is smaller than or equal to the threshold acceleration (“No” in the step S14), the process returns to the step S12.

When it is detected that the mobile device 100 has been thrown in step S15, the movement detection device 230 detects whether the mobile device 100 is located in the movement end area corresponding to the driver activity area 310a (i.e., the front occupant seat area 320a or the rear occupant seat area 320b located immediately behind the driver activity area 310a) in step S16. When it is detected that the mobile device 100 is located in the movement end area corresponding to the driver activity area (“Yes” in the step S16), the movement detection device 230 detects that the mobile device 100 has been thrown from the driver activity area 310a and has landed in the front occupant seat area 320a or the rear occupant seat area 320b located immediately behind the driver activity area 310a in step S17.

Conversely, when the movement detection device 230 detects that the mobile device 100 is not located in the corresponding movement end area (“No” in the step S16), the emergency determination device 240 may determine that no emergency situation has occurred in step S20.

In order to prevent the emergency determination device 240 from determining the situation where the mobile device 100 moves by bouncing away as the vehicle changes its direction while travelling as the emergency situation, the emergency determination device 240 determine whether the emergency condition is met by further referring to the detection result of the sensor 250 provided in the vehicle.

When the movement detection device 230 detects that the mobile device 100 has been thrown from the driver activity area 310a and has landed in the front occupant seat area 320a or the rear occupant seat area 320b located immediately behind the driver activity area 310a in the step S17, the sensor (specifically, the ROA device) detects whether there is a person in the rear occupant seat area in step S18. Based on the sensor detecting that there is no person in the rear occupant seat area (“No” in the step S18), the emergency determination device 240 determines that the emergency condition is not met in the step S20. Conversely, when the ROA device detects that there is a person in the rear occupant seat area (“Yes” in the step S18), the emergency determination device 240 may determine that the emergency condition is met.

Specifically, the emergency situation may be classified as a first emergency situation occurring inside the vehicle and a second emergency situation occurring outside the vehicle. Therefore, the emergency determination device 240 may determine that the emergency condition is met and the first emergency situation seems to have occurred in step S19.

Conversely, when the ROA device detects that there is no person in the rear occupant seat area (“NO” in the step S18), the emergency determination device 240 may determine that no emergency situation has occurred in the step S20.

When the movement detection device 230 detects that the mobile device 100 is not located in the driver activity area 310a (“NO” in the step S11), the movement detection device 230 detects whether the mobile device 100 is located in the driver-side door opening area 310b in step S21.

When it is detected that the mobile device 100 is located in the driver-side door opening area 310b (“Yes” in the step S21), the movement detection device 230 detects whether the change in the location of the mobile device 100 has occurred in step S22. When the change in the location of the mobile device 100 is detected (“Yes” in the step S22), the movement detection device 230 calculates the acceleration of the mobile device 100 in real time in step S23, and determines whether the calculated acceleration is greater than the threshold acceleration in step S24. When the calculated acceleration is greater than the threshold acceleration (“Yes” in the step S24), the movement detection device 230 detects that the mobile device 100 has been thrown in step S25. When the calculated acceleration is smaller than or equal to the threshold acceleration (“No” in the step S24), the process returns to the step S22.

When it is detected that the mobile device 100 has been thrown in the step S25, the movement detection device 230 detects whether the mobile device 100 is located in the movement end area corresponding to the driver-side door opening area 310b (i.e., one of the driver seat area 320h, the front occupant seat area 320a, the rear occupant seat area 320b located immediately behind the driver activity area 310a, the rear occupant seat area 320c located immediately behind the front occupant seat area 320a, the area 320d located immediately in front of the driver-side door opening area 310b, the area 320e located immediately behind the driver-side door opening area 310b, the vehicle front area 320f, and the vehicle side area 320g close to the vehicle) in step S26. When it is detected that the mobile device 100 is located in the movement end area corresponding to the driver-side door opening area 310b (“Yes” in the step S26), the movement detection device 230 detects that the mobile device 100 has been thrown from the driver-side door opening area 310b and has landed in the corresponding movement end area in step S27. The emergency determination device 240 may determine that the emergency condition is met and the second emergency situation seems to have occurred because the emergency situation has occurred outside the vehicle in step S30.

Conversely, when the movement detection device 230 detects that the mobile device 100 is not located in the corresponding movement end area (“No” in the step S26), the emergency determination device 240 may determine that no emergency situation has occurred in step S28.

When the movement detection device 230 detects that the mobile device 100 is not located in the driver-side door opening area 310b (“NO” in the step S21), the movement detection device 230 detects whether the mobile device 100 is located in the vehicle side area 310c far away from the vehicle in step S31.

When it is detected that the mobile device 100 is located in the vehicle side area 310c far away from the vehicle (“Yes” in the step S31), the movement detection device 230 detects whether the change in the location of the mobile device 100 has occurred in step S32. When the change in the location of the mobile device 100 is detected (“Yes” in the step S32), the movement detection device 230 calculates the acceleration of the mobile device 100 in real time in step S33, and determines whether the calculated acceleration is greater than the threshold acceleration in step S34. When the calculated acceleration is greater than the threshold acceleration (“Yes” in the step S34), the movement detection device 230 detects that the mobile device 100 has been thrown in step S35. When the calculated acceleration is smaller than or equal to the threshold acceleration (“No” in the step S34), the process returns to the step S32.

When it is detected that the mobile device 100 has been thrown in the step S35, the movement detection device detects whether the mobile device 100 is located in the movement end area corresponding to the vehicle side area 310c far away from the vehicle (i.e., one of the area 320d located immediately in front of the driver-side door opening area 310b, the area 320e located immediately behind the driver-side door opening area 310b, the vehicle front area 320f, and the vehicle side area 320g close to the vehicle) in step S36. When it is detected that the mobile device 100 is located in the movement end area corresponding to the vehicle side area 310c far away from the vehicle (“Yes” in the step S36), the movement detection device 230 detects that the mobile device 100 has been thrown from the vehicle side area 310c and has landed in the corresponding movement end area in step S37. The emergency determination device 240 may determine that the emergency condition is met and the second emergency situation seems to have occurred in the step S30.

Conversely, when the movement detection device 230 detects that the mobile device 100 is not located in the corresponding movement end area (“No” in the step S36), the emergency determination device 240 may determine that no emergency situation has occurred in step S38.

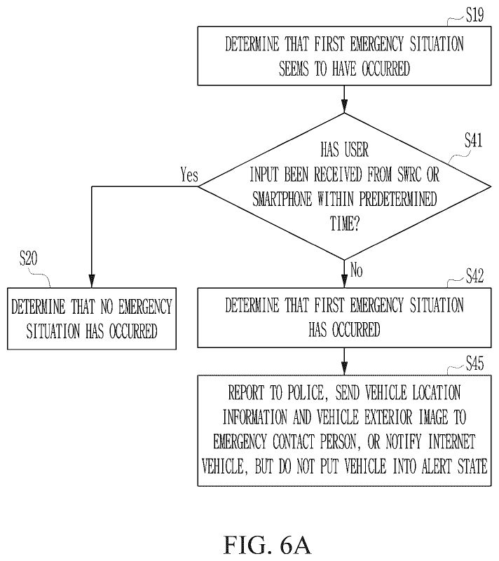

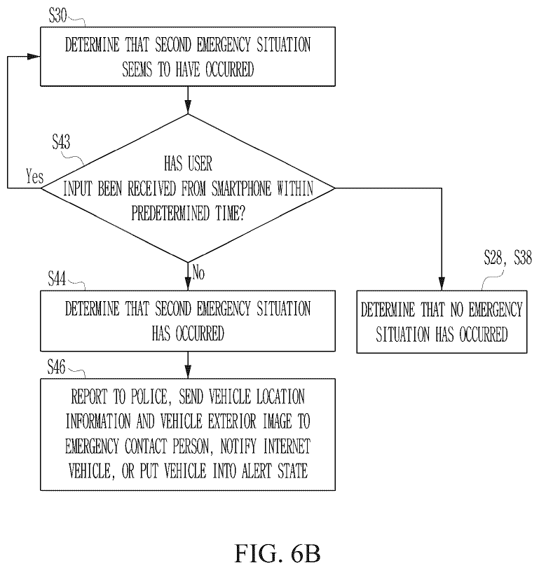

The driver may finally determine whether the emergency situation has occurred. FIGS. 6A and 6B illustrate a flowchart of steps for finally determining whether the emergency situation has occurred. Referring to FIGS. 6A and 6B, when the emergency determination device 240 determines that the emergency condition is met, that is, when it is primarily determined that the first emergency situation in the step S19 or the second emergency situation in the step S30 seems to have occurred, the emergency determination device 240 may send the message to the mobile device 100 regarding the mobile device 100 having been thrown, and the mobile device 100 may display the message.

As illustrated in FIG. 6A, when it is primarily determined that the first emergency situation seems to have occurred in the step S19, the driver may confirm the message through the SWRC installed on the steering wheel or the confirmation button on the smartphone because the driver is inside the vehicle. Therefore, the emergency determination device 240 may determine whether the user input confirming the message that the smartphone has been thrown has been received from the SWRC or the smartphone within the predetermined time (e.g., 10 seconds) in step S41. When the emergency determination device 240 receives the user input confirming the message from the SWRC or the smartphone within the predetermined time (“Yes” in the step S41), the emergency determination device 240 may finally determine that no first emergency situation has occurred in the step S20. When the emergency determination device 240 does not receive the signal confirming the message from the SWRC or the smartphone within the predetermined time (“No” in the step S41), the emergency determination device 240 may finally determine that the first emergency situation has occurred in step S42.

As illustrated in FIG. 6B, when it is primarily determined that the second emergency situation seems to have occurred in the step S30, the driver may confirm the message only through the confirmation button on the smartphone because the driver is getting on or off the vehicle or is located far away from the vehicle. Therefore, the emergency determination device 240 may determine whether the user input for confirming the message that the smartphone has been thrown has been received from the smartphone within the predetermined time in step S43. When the emergency determination device 240 receives the user input confirming the message from the smartphone within the predetermined time (“Yes” in the step S43), the emergency determination device 240 may finally determine that no second emergency situation has occurred in the step S28 or S38. When the emergency determination device 240 does not receive the signal confirming the message from the smartphone within the predetermined time (“No” in the step S43), the emergency determination device 240 may finally determine that the second emergency situation has occurred in step S44.

When the emergency determination device 240 finally determines that the emergency situation has occurred, the occurrence of the emergency situation is notified by the notification device 260.

The notifying of the occurrence of the emergency situation by the notification device 260 includes notifying the occurrence of the emergency situation by at least one way among reporting to police, sending the vehicle location information and the vehicle exterior image to the emergency contact person, notifying the Internet vehicle, and putting the vehicle into the alert state.

In one example, the notification device 260 may notify the occurrence of the emergency situation in a different way depending on the movement start area from which the mobile device 100 has been thrown. That is, the method of notifying the occurrence of the emergency situation is different depending on whether the emergency situation is the first emergency situation or the second emergency situation.

When the emergency determination device 240 finally determines that the first emergency situation has occurred in the step S42, the notification device 260 notifies the occurrence of the emergency situation by at least one way among reporting to police, sending the vehicle location information and the vehicle exterior image to the emergency contact person, and notifying the Internet vehicle; but, the notification device 260 does not notify the occurrence of the emergency situation by putting the vehicle into thee alert state, because the vehicle may be operating normally in step S45.

When the emergency determination device 240 finally determines that the second emergency situation has occurred in the step S44, the notification device 260 may notify the occurrence of the emergency situation not only by at least one of reporting to police, sending the vehicle location information and the vehicle exterior image to the emergency contact person, and notifying the Internet vehicle but also by putting the vehicle into the alert state, because the vehicle is stopped in step S46.

If an occupant is kidnapped, robbed, attacked or beaten by a criminal while getting on or off the vehicle or inside the vehicle, the occupant can notify the occurrence of such the emergency situation and ask for help by throwing the mobile device 100 (e.g., smartphone) to covertly send the alert.

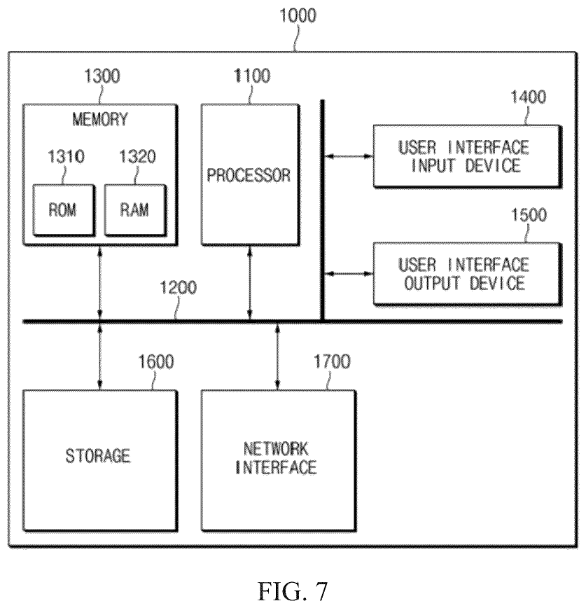

FIG. 7 shows an example computing system (e.g., a computing device of a vehicle or any other apparatus). Any of the devices, the controllers, the processors, etc. described herein may be implemented by the computing system or may be implemented in the computing system.

Referring to FIG. 7, a computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

A system is provided for processing an emergency situation occurring while using a vehicle. The system includes: a plurality of transmitters, each provided at one of a plurality of locations of the vehicle and configured to transmit a request signal forming a detection area inside or outside the vehicle; a receiver provided in the vehicle, and configured to receive a response signal transmitted by a mobile device in response to the request signal when the mobile device enters the detection area; a movement detection device configured to detect a movement of the mobile device based on the response signal of the mobile device and the request signal of the transmitters; an emergency determination device configured to classify at least some of the detection areas into at least one movement start area and at least one movement end area, and determine that an emergency condition is met based on the movement detection device detecting that the mobile device has been thrown from the movement start area and has landed in the movement end area; and a notification device configured to notify that an emergency situation has occurred when the emergency condition is met.

The movement detection device may be configured to: calculate an acceleration of the mobile device in real time when a change in a location of the mobile device is detected; and detect that the mobile device has been thrown when the calculated acceleration is greater than an acceleration threshold.

The acceleration of the mobile device may be calculated by the following formula:

$$a = \sqrt{{( \frac{{x}_{t + Δ t} - {x}_{t}}{Δ {t}^{2}} )}^{2} + {( \frac{{y}_{t + Δ t} - {y}_{t}}{Δ {t}^{2}} )}^{2}}$$

where a denotes the acceleration of the mobile device, Δt denotes an elapsed time, xₜ denotes a horizontal coordinate of a location of the mobile device at a current time t, yₜ denotes a vertical coordinate of the location of the mobile device at the current time t, x_{t+Δt} denotes a horizontal coordinate of a location of the mobile device after the elapsed time Δt, and y_{t+Δt} denotes a vertical coordinate of the location of the mobile device after the elapsed time Δt.

When the movement start area is a driver activity area, the movement end area corresponding to the driver activity area may include a front occupant seat area or a rear occupant seat area located immediately behind the driver activity area; when the movement start area is a driver-side door opening area, the movement end area corresponding to the driver-side door opening area may include one of a driver seat area, the front occupant seat area, the rear occupant seat area located immediately behind the driver activity area, a rear occupant seat area located immediately behind the front occupant seat area, an area located immediately in front of the driver-side door opening area, an area located immediately behind the driver-side door opening area, a vehicle front area, and a vehicle side area close to the vehicle; and when the movement start area is a vehicle side area far away from the vehicle, the movement end area corresponding to the vehicle side area far away from the vehicle may include one of the area located immediately in front of the driver-side door opening area, the area located immediately behind the driver-side door opening area, the vehicle front area, and the vehicle side area close to the vehicle.

The movement detection device may be configured to: sequentially detect whether the mobile device is located in one movement start area among the driver activity area, the driver-side door opening area, and the vehicle side area far away from the vehicle; detect whether the change in the location of the mobile device has occurred when it is detected that the mobile device is located in the one movement start area; calculate an acceleration of the mobile device when the change in the location of the mobile device is detected, determine whether the calculated acceleration is greater than an acceleration threshold, and detect that the mobile device has been thrown when the calculated acceleration is greater than the acceleration threshold; detect whether the mobile device is located in the movement end area corresponding to the one movement start area when it is detected that the mobile device has been thrown; and detect that the mobile device has been thrown from the one movement start area and has landed in the movement end area when it is detected that the mobile device is located in the movement end area corresponding to the one movement start area.

The system may further include: a sensor configured to detect whether there is a person in the rear occupant seat area, wherein the emergency determination device is configured to determine that the emergency condition is not met based on the sensor detecting that there is no person in the rear occupant seat area when the movement detection device detects that the mobile device has been thrown from the driver activity area and has landed in the front occupant seat area or the rear occupant seat area located immediately behind the driver activity area.

The emergency determination device may be further configured to send a message to the mobile device regarding the mobile device having been thrown when the emergency condition is met, and finally determine that no emergency situation has occurred based on the emergency determination device receiving a user input confirming the message by the mobile device and/or a button installed on a steering wheel within a predetermined time; and the notification device may be configured to notify an occurrence of the emergency situation when it is determined that the emergency situation has occurred.

The notification device may be configured to notify the occurrence of the emergency situation by at least one way among reporting to police, sending vehicle location information and a vehicle exterior image to an emergency contact person, notifying an Internet vehicle, and putting the vehicle into an alert state.

The notification device may be configured to notify the occurrence of the emergency situation in a different way depending on the movement start area from which the mobile device has been thrown.

The notification device may be configured not to notify the occurrence of the emergency situation by putting the vehicle into the alert state, based on the movement detection device detecting that the mobile device has been thrown from the driver activity area and has landed in the front occupant seat area or the rear occupant seat area located immediately behind the driver activity area.

A method is provided for processing an emergency situation occurring while using a vehicle. The method includes: transmitting, by a plurality of transmitters installed at a plurality of locations of the vehicle, a request signal forming a detection area inside or outside the vehicle; receiving, by a receiver installed in the vehicle, a response signal transmitted from a mobile device in response to the request signal when the mobile device enters the detection area; classifying, by an emergency determination device, at least some of the detection areas into at least one movement start area and at least one movement end area; detecting, by a movement detection device, whether the mobile device has been thrown from the movement start area and has landed in the movement end area based on the response signal of the mobile device and the request signal of the transmitter; determining, by the emergency determination device, that an emergency condition is met based on the movement detection device detecting that the mobile device has been thrown from the movement start area and has landed in the movement end area; and notifying, by a notification device, that an emergency situation has occurred when the emergency condition is met.

The detecting whether the mobile device has been thrown from the movement start area and has landed in the movement end area may include: calculating, by the movement detection device, an acceleration of the mobile device in real time when a change in a location of the mobile device is detected; and detecting, by the movement detection device, that the mobile device has been thrown when the calculated acceleration is greater than an acceleration threshold.

The acceleration of the mobile device may be calculated by the following formula:

$$a = \sqrt{{( \frac{{x}_{t + Δ t} - {x}_{t}}{Δ {t}^{2}} )}^{2} + {( \frac{{y}_{t + Δ t} - {y}_{t}}{Δ {t}^{2}} )}^{2}}$$

where a denotes the acceleration of the mobile device, Δt denotes an elapsed time, xₜ denotes a horizontal coordinate of a location of the mobile device at a current time t, yₜ denotes a vertical coordinate of the location of the mobile device at the current time t, x_{t+Δt} denotes a horizontal coordinate of a location of the mobile device after the elapsed time Δt, and y_{t+Δt} denotes a vertical coordinate of the location of the mobile device after the elapsed time Δt.

When the movement start area is a driver activity area, the movement end area corresponding to the driver activity area may include a front occupant seat area or a rear occupant seat area located immediately behind the driver activity area; when the movement start area is a driver-side door opening area, the movement end area corresponding to the driver-side door opening area may include one of a driver seat area, the front occupant seat area, the rear occupant seat area located immediately behind the driver activity area, a rear occupant seat area located immediately behind the front occupant seat area, an area located immediately in front of the driver-side door opening area, an area located immediately behind the driver-side door opening area, a vehicle front area, and a vehicle side area close to the vehicle, and when the movement start area is a vehicle side area far away from the vehicle, the movement end area corresponding to the vehicle side area far away from the vehicle may include one of the area located immediately in front of the driver-side door opening area, the area located immediately behind the driver-side door opening area, the vehicle front area, and the vehicle side area close to the vehicle.

The detecting whether the mobile device has been thrown from the movement start area and has landed in the movement end area may include: detecting, by the movement detection device, whether the mobile device is located in the driver activity area; detecting, by the movement detection device, whether the change in the location of the mobile device has occurred when it is detected that the mobile device is located in the driver activity area; calculating an acceleration of the mobile device when the change in the location of the mobile device is detected; determining whether the calculated acceleration is greater than an acceleration threshold; detecting whether the mobile device is located in the movement end area corresponding to the driver activity area when the calculated acceleration is greater than the acceleration threshold; detecting that the mobile device has been thrown from the movement start area and has landed in the movement end area when it is detected that the mobile device is located in the movement end area corresponding to the driver activity area; detecting whether the mobile device is located in the driver-side door opening area when it is detected that the mobile device is not located in the driver activity area; detecting whether the change in the location of the mobile device has occurred when it is detected that the mobile device is located in the driver-side door opening area; calculating the acceleration of the mobile device when the change in the location of the mobile device is detected; determining whether the calculated acceleration is greater than the acceleration threshold; detecting whether the mobile device is located in the movement end area corresponding to the driver-side door opening area when the calculated acceleration is greater than the acceleration threshold; detecting that the mobile device has been thrown from the movement start area and has landed in the movement end area when it is detected that the mobile device is located in the movement end area corresponding to the driver-side door opening area; detecting whether the mobile device is located in the vehicle side area far away from the vehicle when it is detected that the mobile device is not located in the driver-side door opening area; detecting whether the change in the location of the mobile device has occurred when it is detected that the mobile device is located in the vehicle side area far away from the vehicle; calculating the acceleration of the mobile device when the change in the location of the mobile device is detected; determining whether the calculated acceleration is greater than the acceleration threshold; detecting whether the mobile device is located in the movement end area corresponding to the vehicle side area far away from the vehicle when the calculated acceleration is greater than the acceleration threshold; and detecting that the mobile device has been thrown from the movement start area and has landed in the movement end area when it is detected that the mobile device is located in the movement end area corresponding to the vehicle side area far away from the vehicle.

The method may further include: detecting, by a sensor, whether there is no person in the rear occupant seat area when it is detected that the mobile device has been thrown from the driver activity area and has landed in the front occupant seat area or the rear occupant seat area located immediately behind the driver activity area; and determining, by the emergency determination device, that the emergency condition is not met when it is detected that there is no person in the rear occupant seat area.

The method may further include: sending, by the emergency determination device, a message to the mobile device regarding the mobile device having been thrown when it is detected that the emergency condition is met; finally determining, by the emergency determination device, that no emergency situation has occurred based on the emergency determination device receiving a user input confirming the message by the mobile device and/or a button installed on a steering wheel within a predetermined time; and notifying, by the notification device, an occurrence of the emergency situation when the emergency determination device finally determines that the emergency situation has occurred.

The notifying by the notification device that an emergency situation has occurred may include: notifying, by the notification device, the occurrence of the emergency situation by at least one way among reporting to police, sending vehicle location information and a vehicle exterior image to an emergency contact person, notifying an Internet vehicle, and putting the vehicle into an alert state.

The notifying by the notification device that an emergency situation has occurred may include: notifying, by the notification device, the occurrence of the emergency situation in a different way depending on the movement start area from which the mobile device has been thrown.

The notification device may be configured not to notify the occurrence of the emergency situation by putting the vehicle into the alert state, based on the movement detection device detecting that the mobile device has been thrown from the driver activity area and has landed in the front occupant seat area or the rear occupant seat area located immediately behind the driver activity area.

According to the present disclosure, if an occupant encounters an emergency situation while getting on or off a vehicle or being inside the vehicle, the occupant can notify the occurrence of the emergency situation and ask for help by throwing a mobile device (e.g., a smartphone) to covertly send an alert.

The various example embodiments of the present disclosure are not intended to enumerate all possible combinations, but rather to describe representative aspects of the present disclosure, and furthermore, each the above-described various example embodiments may be applied independently or two or more of the above-described various example embodiments may be applied in combination.

The above-described example embodiments are intended only to describe the technical solutions of the present disclosure, should not be considered complete, and is not intended to limit the present disclosure to the exact form described. Itis needless to say that those skilled in the art may make various modifications and changes according to the above disclosure. The selection and description of example embodiments is intended to interpret the specific principles of the present disclosure and practical applications thereof so that those skilled in the art may utilize each example embodiment of the present disclosure and different alternatives and modifications thereof. The scope of the present disclosure is defined by the appended claims and equivalents thereof.

What is claimed is:

1. A system comprising:
a plurality of transmitters, each provided at a corresponding location of a plurality of locations of a vehicle and configured to transmit a request signal associated with a corresponding detection area of a plurality of detection areas inside or outside the vehicle;
a receiver provided in the vehicle and configured to receive a response signal, wherein the response signal is transmitted by a mobile device in response to the mobile device receiving the request signal after the mobile device enters a detection area of the plurality of detection areas;
a motion sensor configured to detect, based on the response signal of the mobile device and the request signal of the transmitters, a movement of the mobile device;
a processor;
a memory storing at least one instruction that, when executed by the processor communicating with the memory, is configured to cause the system to:
classify at least one of the plurality of detection areas as a movement start area and classify at least one of the plurality of detection areas as a movement end area; and
determine, based on the motion sensor detecting that the mobile device has been thrown from the movement start area and has landed in the movement end area, that an emergency condition is met; and
a communication circuit configured to output, based on the emergency condition being met, a signal indicating that an emergency situation has occurred.

2. The system of claim 1, wherein the motion sensor is further configured to:
determine, based on a change in a location of the mobile device being detected, an acceleration of the mobile device; and
detect, based on the acceleration being greater than a threshold acceleration, that the mobile device has been thrown.

3. The system of claim 2, wherein the motion sensor is configured to determine the acceleration of the mobile device using the following equation:
$$A = \sqrt{{( \frac{{x}_{t + Δ t} - {x}_{t}}{Δ {t}^{2}} )}^{2} + {( \frac{{y}_{t + Δ t} - {y}_{t}}{Δ {t}^{2}} )}^{2}}$$
wherein A denotes the acceleration of the mobile device, wherein Δt denotes an elapsed time, wherein xₜ denotes a horizontal coordinate of a first location of the mobile device at a time t, wherein yₜ denotes a vertical coordinate of the first location of the mobile device at the time t, wherein x_{t+Δt} denotes a horizontal coordinate of a second location of the mobile device after the elapsed time Δt, and wherein y_{t+Δt} denotes a vertical coordinate of the second location of the mobile device after the elapsed time Δt.

4. The system of claim 2, wherein:
based on the movement start area being a driver activity area, the movement end area corresponding to the driver activity area comprises a front occupant seat area or a rear occupant seat area located immediately behind the driver activity area;
based on the movement start area being a driver-side door opening area, the movement end area corresponding to the driver-side door opening area comprises one of a driver seat area, the front occupant seat area, the rear occupant seat area located immediately behind the driver activity area, a rear occupant seat area located immediately behind the front occupant seat area, an area located immediately in front of the driver-side door opening area, an area located immediately behind the driver-side door opening area, a vehicle front area, or a vehicle side area close to the vehicle; or
based on the movement start area being a vehicle side area, the movement end area corresponding to the vehicle side area comprises one of the area located immediately in front of the driver-side door opening area, the area located immediately behind the driver-side door opening area, the vehicle front area, or the vehicle side area close to the vehicle, wherein a distance from the vehicle side area to the vehicle is greater than a threshold distance.

5. The system of claim 4, wherein the motion sensor is further configured to:
sequentially detect whether the mobile device is located in one movement start area among the driver activity area, the driver-side door opening area, and the vehicle side area;
based on detecting that the mobile device is located in the one movement start area, detect whether the change in the location of the mobile device has occurred;
detect, based on detecting that the mobile device has been thrown, whether the mobile device is located in the movement end area corresponding to the one movement start area; and
detect, based on detecting that the mobile device is located in the movement end area corresponding to the one movement start area, that the mobile device has been thrown from the one movement start area and has landed in the movement end area.

6. The system of claim 4, further comprising:
a sensor configured to detect whether there is a person in the rear occupant seat area,
wherein the at least one instruction, when executed by the processor communicating with the memory, is configured to cause the system to determine that the emergency condition is not met based on the sensor detecting that there is no person in the rear occupant seat area when the motion sensor detects that the mobile device has been thrown from the driver activity area and has landed in the front occupant seat area or the rear occupant seat area located immediately behind the driver activity area.

7. The system of claim 2, wherein the at least one instruction, when executed by the processor communicating with the memory, is further configured to cause the system to:
send, to the mobile device, a message indicating that the mobile device has been thrown and that the emergency condition is met; and
determine that the emergency situation is invalid based on the system receiving, within a predetermined time duration, a user input via the mobile device or a button installed on a steering wheel, that the emergency situation has occurred.

8. The system of claim 1, wherein the communication circuit is configured to output the signal indicating that the emergency situation has occurred by performing at least one of: reporting to police, sending vehicle location information to an emergency contact person, sending a vehicle exterior image to the emergency contact person, notifying an Internet vehicle, or placing the vehicle into an alert state.

9. The system of claim 1, wherein the communication circuit is configured to output the signal indicating that the emergency situation has occurred by selecting a notification method based on the movement start area from which the mobile device has been thrown.

10. The system of claim 9, wherein the communication circuit is configured to not notify that the emergency situation has occurred, based on the motion sensor detecting that the mobile device has been thrown from a driver activity area and has landed in a front occupant seat area or a rear occupant seat area located immediately behind the driver activity area.

11. A method performed by an apparatus of a vehicle, the method comprising:
transmitting, via at least one of a plurality of transmitters installed at a plurality of locations of the vehicle, a request signal associated with a detection area of a plurality of detection areas inside or outside the vehicle;
receiving, via a receiver installed in the vehicle, a response signal, wherein the response signal is transmitted by a mobile device in response to the mobile device receiving the request signal after the mobile device enters the detection area;
classifying at least one of the plurality of detection areas as a movement start area and classifying at least one of the plurality of detection areas as a movement end area;
based on the response signal of the mobile device and the request signal of the transmitter, detecting, via a motion sensor, whether the mobile device has been thrown from the movement start area and has landed in the movement end area;
determining, based on detecting that the mobile device has been thrown from the movement start area and has landed in the movement end area, that an emergency condition is met; and
outputting, based on the emergency condition being met, a signal indicating that an emergency situation has occurred.

12. The method of claim 11, wherein the detecting whether the mobile device has been thrown comprises:
determining, based on a change in a location of the mobile device being detected, an acceleration of the mobile device; and
detecting, based on the acceleration being greater than a threshold acceleration, that the mobile device has been thrown.

13. The method of claim 12, wherein the determining of the acceleration comprises:
determining the acceleration of the mobile device using the following equation:
$$A = \sqrt{{( \frac{{x}_{t + Δ t} - {x}_{t}}{Δ {t}^{2}} )}^{2} + {( \frac{{y}_{t + Δ t} - {y}_{t}}{Δ {t}^{2}} )}^{2}}$$
wherein A denotes the acceleration of the mobile device, wherein Δt denotes an elapsed time, wherein xₜ denotes a horizontal coordinate of a first location of the mobile device at a time t, wherein yₜ denotes a vertical coordinate of the first location of the mobile device at the time t, wherein x_{t+Δt} denotes a horizontal coordinate of a second location of the mobile device after the elapsed time Δt, and wherein y_{t+Δt} denotes a vertical coordinate of the second location of the mobile device after the elapsed time Δt.

14. The method of claim 12, wherein:
based on the movement start area being a driver activity area, the movement end area corresponding to the driver activity area comprises a front occupant seat area or a rear occupant seat area located immediately behind the driver activity area;
based on the movement start area being a driver-side door opening area, the movement end area corresponding to the driver-side door opening area comprises one of a driver seat area, the front occupant seat area, the rear occupant seat area located immediately behind the driver activity area, a rear occupant seat area located immediately behind the front occupant seat area, an area located immediately in front of the driver-side door opening area, an area located immediately behind the driver-side door opening area, a vehicle front area, or a vehicle side area close to the vehicle; or
based on the movement start area being a vehicle side area, the movement end area corresponding to the vehicle side area comprises one of the area located immediately in front of the driver-side door opening area, the area located immediately behind the driver-side door opening area, the vehicle front area, or the vehicle side area close to the vehicle, wherein a distance from the vehicle side area to the vehicle is greater than a threshold distance.

15. The method of claim 14, wherein the detecting of whether the mobile device has been thrown comprises:
based on detecting that the mobile device is located in the one movement start area, detecting whether the change in the location of the mobile device has occurred;
detecting, based on the acceleration being greater than the threshold acceleration, whether the mobile device is located in the movement end area corresponding to the driver activity area; and
detecting, based on detecting that the mobile device is located in the movement end area corresponding to the driver activity area, that the mobile device has been thrown from the movement start area and has landed in the movement end area.

16. The method of claim 14, further comprising:
detecting, by a sensor, whether there is any person in the rear occupant seat area based on the mobile device being detected as having been thrown from the driver activity area and landed in the front occupant seat area or the rear occupant seat area located immediately behind the driver activity area; and
determining that the emergency condition is not met based on the sensor detecting that there is no person in the rear occupant seat area.

17. The method of claim 12, further comprising:
sending, to the mobile device, a message indicating that the mobile device has been thrown and that the emergency condition is met; and
determining that the emergency situation is invalid based on the apparatus receiving, within a predetermined time duration, a user input via the mobile device or a button installed on a steering wheel, that the emergency situation has occurred.

18. The method of claim 11, wherein the outputting of the signal comprises:
performing at least one of: reporting to police, sending vehicle location information to an emergency contact person, sending a vehicle exterior image to the emergency contact person, notifying an Internet vehicle, or placing the vehicle into an alert state.

19. The method of claim 11, wherein the outputting of the signal comprises:
outputting of the signal indicating that the emergency situation has occurred by selecting a notification method based on the movement start area from which the mobile device has been thrown.

20. A vehicle comprising:
a motion sensor configured to detect, based on a location of a mobile device within one of a plurality of detection areas associated with the vehicle, a movement of the mobile device;
a processor;
a memory storing at least one instruction that, when executed by the processor communicating with the memory, is configured to cause the vehicle to:
classify at least one of the plurality of detection areas as a movement start area and classify at least one of the plurality of detection areas as a movement end area; and
determine, based on the motion sensor detecting that the mobile device has been thrown from the movement start area and has landed in the movement end area, that an emergency condition is met and
a communication circuit configured to output, based on the emergency condition being met, a signal indicating that an emergency situation has occurred.
